(19) United States
(12) Patent Application Publication
(10) Pub. No.: US 2006/0079994 A1
(43) Pub. Date: Apr. 13, 2006

(54) Unit-dose medication dispensing cart and method of operating the same

(76) Inventors: Woei Chyn Chu, Taipei City (TW); Chung Lei Huang, Taipei City (TW); Yin Jiun Tseng, Taipei City (TW)

Correspondence Address: BIRCH STEWART KOLASCH & BIRCH, PO BOX 747, FALLS CHURCH, VA, 22040-0747, US

(21) Appl. No.: 11/237,762

(22) Filed: Sep. 29, 2005

(30) Foreign Application Priority Data
Oct. 8, 2004 (TW) 93130495

(51) Int. Cl. G06F 17/00

(52) U.S. Cl. 700/231

(57) ABSTRACT

A unit dose medication dispensing cart is provided. The unit dose medication dispensing cart comprises a plurality of drawers, a plurality of indicators, and a controller. The drawers are used for containing prepackaged unit dose medications. Each of the indicators, capable of emitting a light signal, is mounted on one of the drawer. The controller receives location information, identifies one of the drawers accordingly, and triggers the indicator corresponding to the identified drawer to emit the light signal.

### BACKGROUND

The invention relates to unit dose medication, and particularly to systems and methods facilitating dispensing of unit dose medication.

Errors in dispensing medication are more likely when health professionals engage in multiple tasks within a short time span. This situation occurs repeatedly in hospitals when pharmacists and technicians load prepackaged unit dose medications into dispensing carts, and when nurses administer prepackaged unit dose medications. Dispensing carts are prepared daily, often manually, by technicians and then checked by pharmacists. These dispensing carts, containing thousands of patient-specific unit dose medications, are sent to wards daily, for nurses to administer medications to intended patients. Dosing frequencies vary widely, ranging from regular intervals around the clock to “stat” doses given to control acute pain or other symptoms. Administering medication is an enormous task, and is, therefore, particularly susceptible to errors.

According to a conventional medication procedure, a thorough check is required before administering medication. For example, a nursing staff is required to check identification information of patient and medication, dosage, administration time and route. The check is typically performed using standardized worksheets, treatment flow sheets, or other manual documentation. This method, however, is also error-prone.

Hence, there is a need for a method and system that addresses problems arising from the existing technology and facilitates unit dose medication operation.

### SUMMARY

A unit dose medication dispensing cart is provided. The unit dose medication dispensing cart comprises a plurality of drawers, a plurality of indicators, capable of emitting a light signal, and a controller. The drawers are used for containing prepackaged unit dose medications. Each of the indicators is mounted on one of the drawer. The controller receives location information, identifies one of the drawers accordingly, and triggers the indicator corresponding to the identified drawer to emit the light signal.

A computerized unit dose medication dispensing cart is also provided. The computerized unit dose medication dispensing cart comprises a plurality of drawers, a plurality of indicators, a tag reader, and a computer. The drawers are used for holding prepackaged unit dose medications. Each of the indicators, capable of emitting a light signal, is mounted on one of the drawer. The tag reader is used to retrieve identification information from a tag. The computer receives the identification information from the tag reader, retrieves medication information corresponding to the identification information from a remote database, identifies one of the drawers accordingly, and triggers the indicator corresponding to the identified drawer to emit the light signal.

A computerized unit dose medication dispensing system is also provided. The computerized unit dose medication dispensing system comprises a dispensing cart, a tag reader, a database, and a computer. The dispensing cart is used for transporting prepackaged unit dose medications. The dispensing cart comprises a plurality of drawers and a plurality of indicators. The drawers are used for containing prepackaged unit dose medications. Each of the indicators, capable of emitting a light signal, is mounted on one of the drawer. The tag reader is used for retrieving identification information from a tag. The database stores medication information corresponding to the identification information. The computer receives the identification information from the tag reader, retrieves medication information corresponding to the identification information from the database, identifies one of the drawers accordingly, and triggers the indicator corresponding to the identified drawer to emit the light signal.

A method for unit dose medication dispensing is also provided. A dispensing cart is first provided for transporting prepackaged unit dose medications. The dispensing cart comprises a plurality of drawers and a plurality of indicators. The drawers are used for containing prepackaged unit dose medications. Each of the indicators, capable of emitting a light signal, is mounted on one of the drawer. Patient identification information is retrieved from a first tag. Medication information is retrieved according to the identification information retrieved from the first tag. Operation of the dispensing cart is controlled according to the medication information.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an embodiment of a health care system employing a dispensing cart; and

FIG. 2 is a schematic view of an embodiment of a transport system.

### DETAILED DESCRIPTION

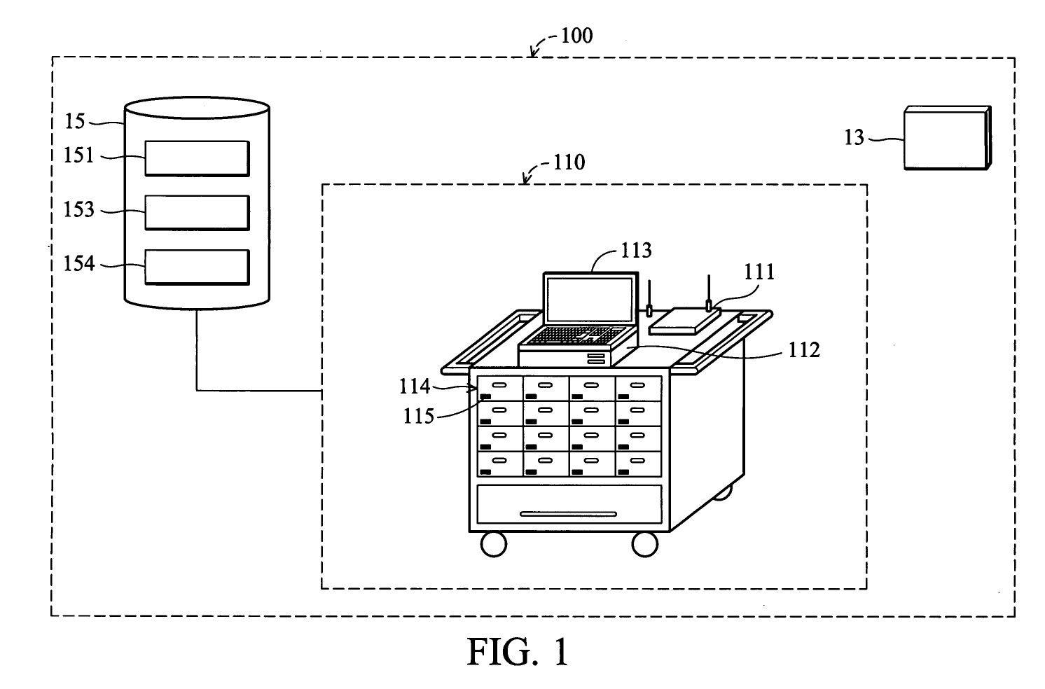

The invention is now described with reference to FIGS. 1 through 6, which in general relate to unit dose medication in a health care environment. Due to the complexity of and differences in practice settings and organizational arrangements, the invention can be implemented in other health care systems.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures.

FIG. 1 is a schematic view of an embodiment of a health care system employing a dispensing cart. A dispensing cart 110, employed in a health care system 100, comprises a plurality of lockable drawers 114. Each drawer 114 is equipped with an indicator 115. The indicator 115 can be a lamp or other type of visual indicator. The dispensing cart 110 is equipped with an RFID reader 111. The RFID reader 111 is used to retrieve data from a RFID tag attached to a nursing staff, a patient, a medication container, or other person or article pertaining to the administration process. When a RFID tag 13 attached to a patient is detected, RFID reader 111 retrieves information stored in RFID tag 13, and the retrieved information is relayed to a computer 112 equipped in the dispensing cart 110. The retrieved information can be presented on a screen 113. The retrieved information is sent from the computer 112 to a remote database 15 via a wireless network (not shown in FIG. 1). The remote database 15 stores patient-specific medical record 155, prescription data 151, and pharmaceutical data 153. Prescription data and pharmaceutical data corresponding to the information retrieved from RFID tag 13 is then transferred to the computer 112, and is used to control the dispensing cart 110. For example, one of lockable drawers 14 can be unlocked according to the prescription data and pharmaceutical data corresponding to the identification number stored in the RFID tag of the patient. Additionally, when a patient is identified, indicator 115 of a corresponding drawer 114 is triggered to emit a light signal, directing nursing staff to open the corresponding drawer, and take out the prepackaged unit dose medication kept in the drawer. Before administering the medication to the patient, the nursing staff can check the medication using the pharmaceutical information presented on the screen 113. For example, the pharmaceutical information may comprise an image of contents contained in the unit dose medication.

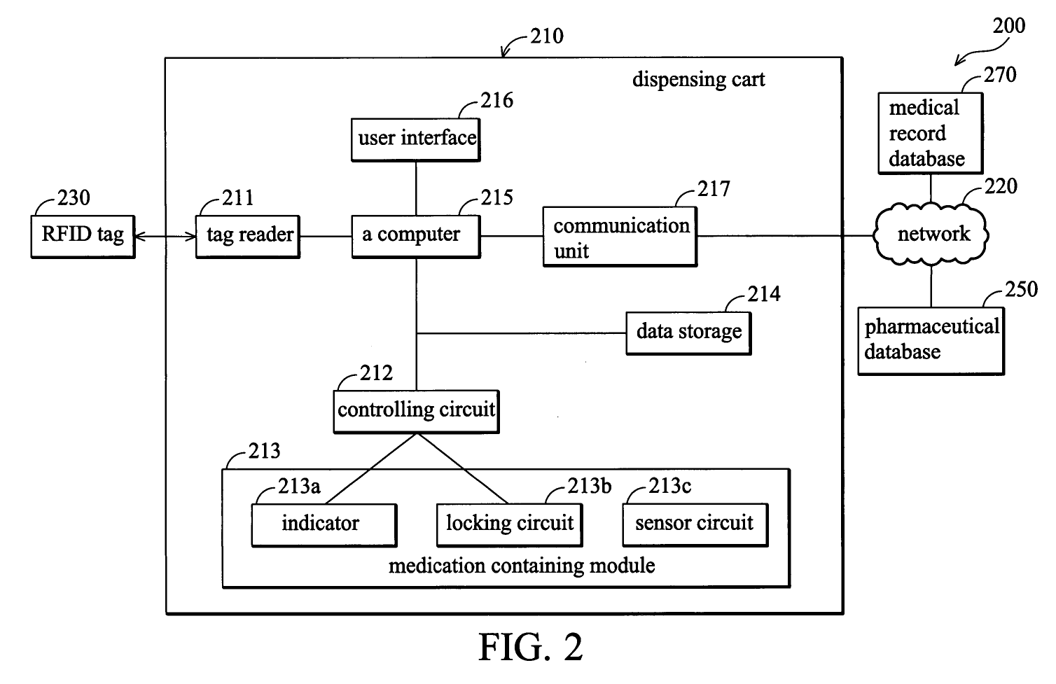

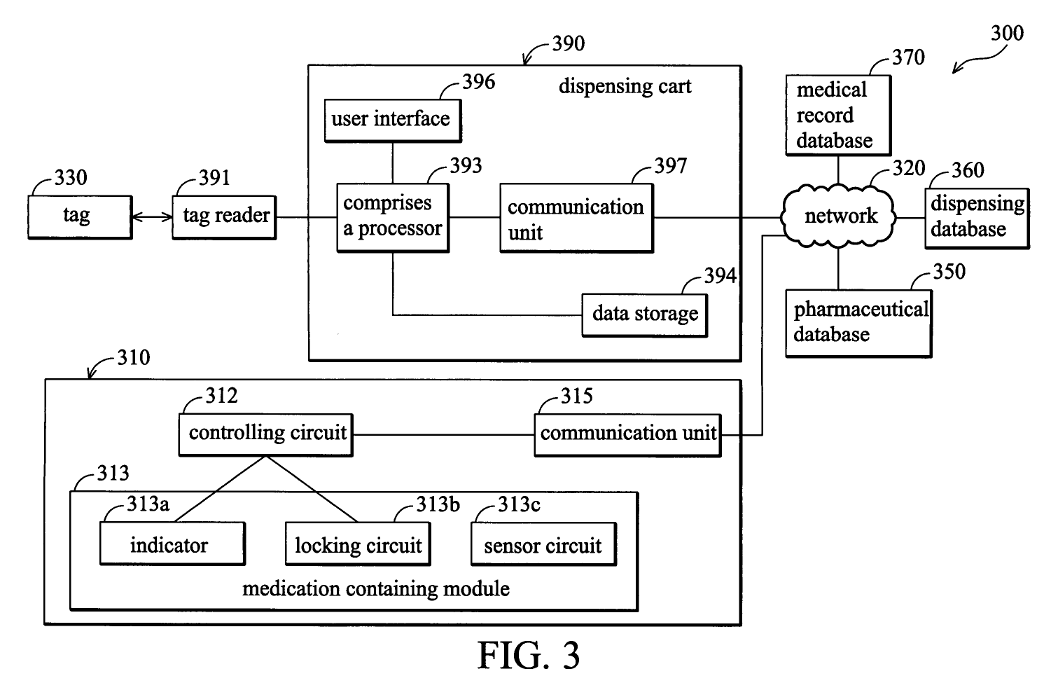

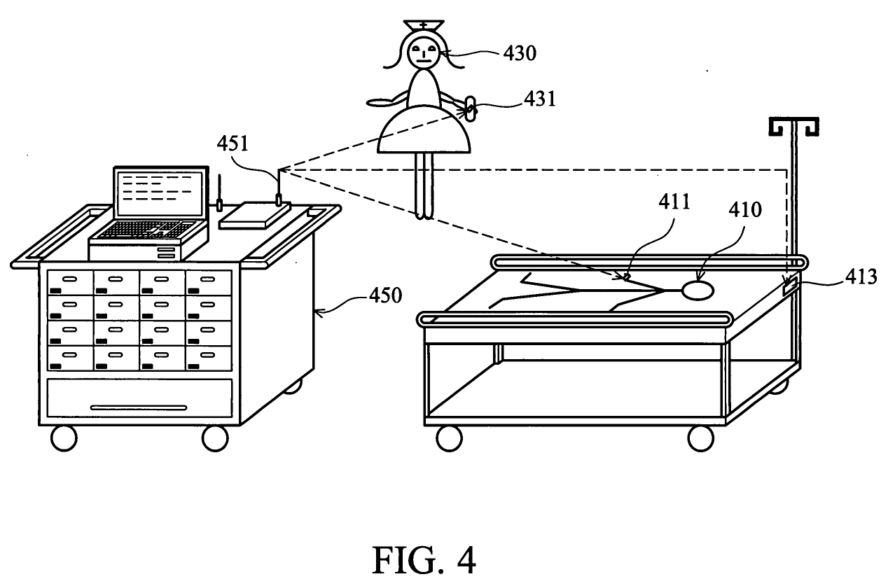

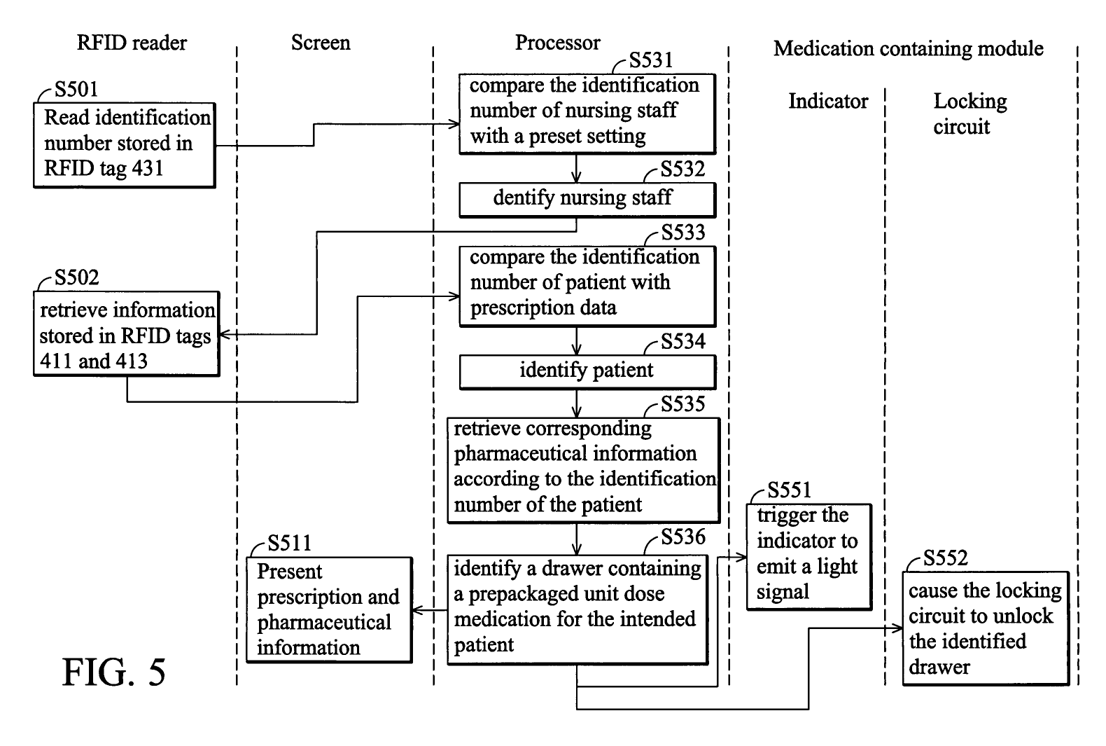

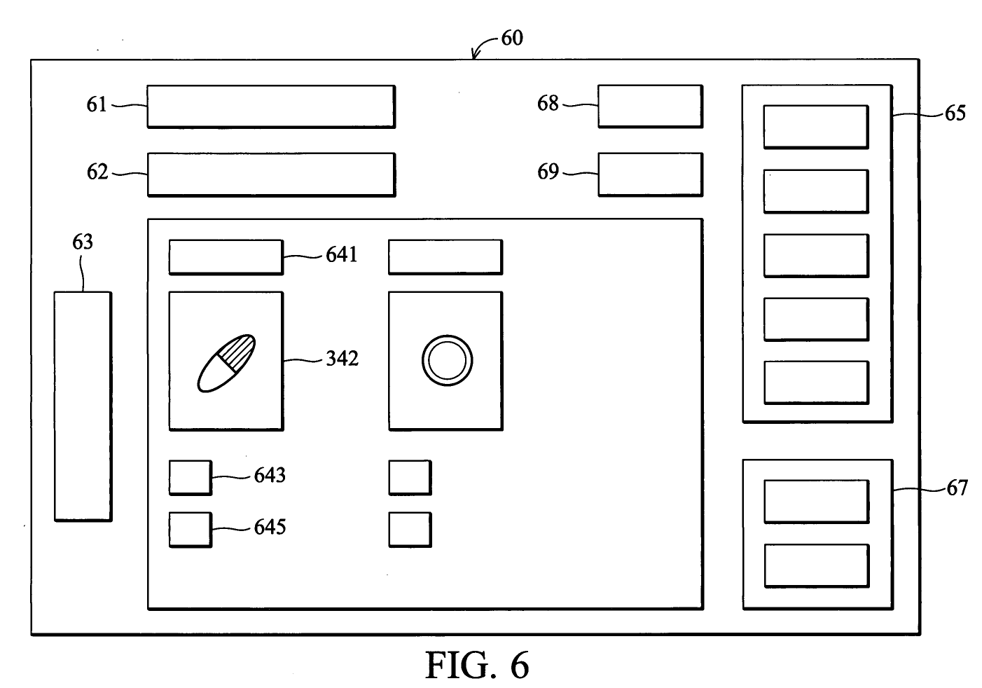

FIG. 2 is a block diagram of an embodiment of a health care system employing a dispensing cart. A health care system 200 comprises a dispensing cart 210, a medical record database 270, and a pharmaceutical database 250. The dispensing cart 210, medical record database 270, and pharmaceutical database 250 communicate via a network 220.

The medical record database 270 and pharmaceutical database 250 are computerized databases. The network 220 can be a wireless network, a wired network, or a combination thereof. The dispensing cart 210 comprises a tag reader 211, a control circuit 212, a medication containing module 213, a data storage 214, a computer 215, a user interface 216, and a communication unit 217.

When unit dose medications are prepared in a pharmacy, the locations in which unit dose medications are kept is stored in data storage 214. Medication containing module 213 comprises a plurality of drawers, each of which is equipped with an indicator 213a, a locking circuit 213b, and a sensor circuit 213c. The user interface 216 may comprise a screen, a touch panel, a keyboard, or other device capable of communicating with a user. The tag reader 211 can be an RFID reader retrieving data from an RFID tag, or a bar-code reader retrieving data from a bar-code tag. Here, the tag reader 211 is an RFID reader retrieving data from an RFID tag 230. The RFID tag 230 can be attached to a person or an article. For example, the RFID tag can be attached to a nursing staff, a patient, a medication container, or other person or article pertaining to the administration process. When an RFID tag 230 mounted on a patient is detected, RFID reader 211 retrieves information stored in RFID tag 230, and the retrieved information is relayed to a computer 215 equipped in the dispensing cart 210. The retrieved information can be presented on user interface 216. The retrieved information is used for retrieving corresponding information from medical record database 270 and pharmaceutical database 250. The computer 215 communicates with medical record database 270 and pharmaceutical database 250 via communication unit 217 and network 220.

The medical record database 270 stores patient-specific medical records and prescription data. For example, the medical record database 270 comprises medical profiles for each patient receiving health care services from the health care system. The medical profile may comprise at least the following information pertaining to a specific patient: patient's name and a unique identifying code or number; a medical history, known drug-related adverse events, allergies, and medication-, nutrient, and -food sensitivities; vital statistics that may affect treatment intensity, particularly those needed to calculate medication doses; data about all medications used by the patient, including the date the medications were prescribed, prepared, dispensed, drug identity, drug dosage, total drug dosage administered per unit interval, administration route, administration, schedules, rate of administration, prescribed duration of use, and the product manufacturer's identity and product lot numbers and expiration dates for drugs dispensed from that facility; additional ingredients and diluting agents and the amount used in extemporaneously compounded medications; an up-to-date treatment history. The data stored in the medical record database 270 may be modified to meet requirements. The prescription information stored in the medical record database 270 may be provided via a computerized prescriber order entry (CPOE) mechanism.

The pharmaceutical database 250 stores pharmaceutical data. For example, the pharmaceutical database 250 may store a pharmacopeia, providing drug information such as the appearance of a specific drug.

Prescription data and pharmaceutical data corresponding to the information retrieved from the tag is then transferred to the computer 215, and is used to control the dispensing cart 210 through control circuit 212. For example, when an identification number stored in an RFID tag of a specific patient is retrieved, a corresponding patient name is retrieved and corresponding prescription information is retrieved from the medical record database 270. The prescription information is used to retrieve corresponding drug information contained in the unit dose medication intended to administer to the patient. Additionally, the location information stored in data storage 214 is used for identifying a corresponding drawer containing the corresponding prepackaged unit dose medication. When the drawer is identified, the control circuit 212 triggers indicator 213a of the medication containing module 213 to emit a light signal indicating that the identified drawer contains prepackaged unit dose medication intended for the specific patient. Additionally, control circuit 212 controls locking circuit 213b to unlock the identified drawer, thus the nursing staff can access the unit dose medication contained in the drawer.

The drug information, such as appearance of drugs contained in the prepackaged unit dose medication, is presented on user interface 216. The nursing staff can confirm the drugs contained in the prepackaged unit dose medication by checking the appearance presented on the user interface 216. Additionally, the nursing staff can input confirm result to computer 211 via the user interface 216.

FIG. 3 is a block diagram of another embodiment of a health care system employing a dispensing cart. A health care system 300 comprises a dispensing database 360, a dispensing cart 310, a computer 390, a medical record database 370, and a pharmaceutical database 350. The dispensing cart 310, computer 390, medical record database 370, and pharmaceutical database 350 communicate via a network 320. The network 320 can be a wireless network, a wired network, or a combination thereof. The medical record database 270 and pharmaceutical database 250 are computerized databases.

Unlike the embodiment described in FIG. 2, computer 390 is not incorporated in dispensing cart 310. The dispensing cart 310 comprises a communication unit 315, a control circuit 312 and a medication containing module 313. The communication unit 315 is used to communicate with other devices, such as computer 390, via the network 320. The control circuit 312 controls operation of medication containing module 313. The medication containing module 313 comprises a plurality of medication containers, such as drawers (not shown in FIG. 3). Each of the drawers is equipped with an indicator 313a, a locking circuit 213b, and a sensor circuit 213c. The computer 390 comprises a processor 393, data storage 394, a user interface 396, and a communication unit 397. Additionally, computer 390 is connected to a tag reader 391.

When unit dose medications are prepared in a pharmacy, the locations in which unit dose medications are stored is stored in dispensing database 360. The location information stored in the dispensing database 360 is then downloaded in data storage 394. The user interface 396 may comprise a screen, a touch panel, a keyboard, or other device capable of communicating with a user. The tag reader 391 can be a RFID reader retrieving data from a RFID tag, or a bar-code reader retrieving data from a bar-code tag.

Here, the tag reader 391 is an RFID reader retrieving data from an RFID tag 330. The RFID tag 330 can be attached to a nursing staff, a patient, a medication container, or other person or article pertaining to the administration process. When an RFID tag 330 attached on a patient is detected, RFID reader 391 retrieves information stored in RFID tag 330, and the retrieved information is relayed to processor 393. The retrieved information can be presented on user interface 396. The retrieved information is used for retrieving corresponding information from medical record database 370 and pharmaceutical database 350. The processor 393 communicates with medical record database 370 and pharmaceutical database 350 via communication unit 397 and network 320. The medical record database 370 stores patient-specific medical record and prescription data. For example, the medical record database 370 comprises medical profiles for each patient receiving health care from the health care system. The data stored in the medical record database 370 may be modified to meet requirements. The prescription information stored in the medical record database 370 may be provided via a computerized prescriber order entry (CPOE) mechanism.

The pharmaceutical database 350 stores pharmaceutical data. For example, the pharmaceutical database 350 may store a pharmacopeia, providing drug information such as the appearance of a specific drug.

Prescription data and pharmaceutical data corresponding to the information retrieved from the tag is then transferred to the processor 393, and is used to control the dispensing cart 310 through control circuit 312. For example, when identification number stored in a RFID tag of a specific patient is retrieved, a corresponding patient name is retrieved and corresponding prescription information is retrieved from the medical record database 370. The prescription information is used to retrieve corresponding drug information contained in the unit dose medication intended for administration to the patient. Additionally, the prescription information is used for identifying a corresponding drawer containing the corresponding prepackaged unit dose medication. When the drawer is identified, the control circuit 312 triggers indicator 313a of the medication containing module 313 to emit a light signal indicating that the specific drawer contains prepackaged unit dose medication intended for the specific patient. Additionally, control circuit 312 controls locking circuit 313b to unlock the identified drawer, thus, nursing staff can access the unit dose medication contained in the drawer.

The drug information, such as the appearance of drugs contained in the prepackaged unit dose medication, is presented on user interface 396. The nursing staff can confirm the drugs contained in the prepackaged unit dose medication by checking the appearance presented on the user interface 396. Additionally, the nursing staff can input a confirmation result to computer 390 via the user interface 396.

Using FIG. 4 as an example, in an inpatient setting, a dispensing cart of FIG. 2 or FIG. 3 can be employed. A patient 410 wears an RFID tag 411 storing an identification number. Patient 411 lies on a bed with an attached RFID tag 413. Nursing staff 430, caring for the patient 410, wears an RFID tag 431. Also referring to FIG. 5, when nursing staff 430 is to administer medication to the intended patient 410, the identification number stored in the RFID tag 431 is first read by an RFID reader 451 equipped in a dispensing cart 450. (step S501). In step S531, the identification number of nursing staff 430 is compared with a preset setting stored in a remote database. The computer operating with the dispensing cart 450 can access the remote database via a wireless network. In step S532, nursing staff 450 is identified and confirmed according to the checking process of step S531. In step S502, information stored in RFID tags 411 and 413 are retrieved by RFID reader 451. The retrieved information is relayed to a computer operating with dispensing cart 450. In step S533, the identification number of patient 410 is compared with data in a remote prescription database. In step S534, patient 410 is identified and confirmed, and corresponding prescription information is retrieved from the remote prescription database. The retrieved prescription information is used for retrieving corresponding pharmaceutical information form a remote pharmaceutical database (step S535) The retrieved prescription and pharmaceutical information is presented on a screen operating with the dispensing cart 450 (step S511). Additionally, the identification number of patient 410 is compared with location information stored in a local storage device operating with dispensing cart 450, and a drawer containing a prepackaged unit dose medication for the intended patient 410 is identified (step S536). After the drawer is identified, control signals are sent to an indicator and locking circuit corresponding to the identified drawer. In step S551, the indicator is triggered to emit a light signal according to the control signal. In step S552, the locking circuit unlocks the identified drawer.

Additionally, the information presented in step S511 can be displayed as a check list (as shown in FIG. 6). FIG. 6 shows a brief block diagram of an embodiment of a screen presented to a nursing staff. The remote prescription and pharmaceutical databases provide prescription information corresponding to the identified patient, as well as pharmaceutical information of a prepackaged unit dose medication intended for the identified patient. Screen 60 comprises a patient confirmation field 61 and a bed confirmation field 62, in which confirmation results corresponding to the identification numbers stored in RFID tags 411 and 413 are displayed. Medication container status field 63 indicates a specific drawer equipped in the dispensing cart, and specifies operation status of the medication containing module of the dispensing cart. Drug information field 64 illustrates pharmaceutical information of each drug contained in the prepackaged unit dose medication for the identified patient. For example, the pharmaceutical information of a particular drug may comprise a drug name 641, a drug appearance image 642, a check box 643, and an alarm trigger 645. The pharmaceutical information is confirmed with the prescription and pharmaceutical information retrieved from the remote prescription and pharmaceutical databases according to the identification number stored in RFID tags 411 and 413. Nursing staff can check the contents contained in the prepackaged unit dose medication using the drug appearance image 642. When contents contained in the prepackaged unit dose medication does not confirm to the drug appearance images shown in drug information field 64, alarm trigger 645 can be actuated, and an alarm signal is sent to a responsible staff member, such as a pharmacist. Field 65 comprises several buttons used for medication verification. Field 65 comprises buttons corresponding to several check points of a medication verification process. For example, field 65 may comprise buttons corresponding to checkpoints of patient identification, bed identification, medication contents confirmation, administration route, and administration dosage. Field 68 comprises administration time recorded in predetermined prescription information. Field 69 comprises system time determined by the computer operating with the dispensing cart. On the right side of the screen 60 is a frame 67, providing several functional buttons for activating different verification functions. For example, when a dosage calculation function is actuated, appropriate dosages for an intended patient are calculated, by which constraints for the maximum dose of medication that can be safely given during a single administration is determined according to the medical record corresponding to the intended patient. Additionally, potential adverse effects can be provided by actuating a function button. Potential drug interaction may be presented by actuating another function button.

Screen 60 is made up of multiple frames and fields, providing different type of tools and information. The actual arrangement of the frames, fields, and other content of this page may vary as desired.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A unit dose medication dispensing cart, comprising:
a plurality of drawers for containing prepackaged unit dose medications;
a plurality of indicators, each of which is mounted on one of the drawers, capable of emitting a light signal; and
a controller receiving location information, identifying one of the drawers accordingly, and triggering the indicator corresponding to the identified drawer to emit the light signal.

2. The unit dose medication dispensing cart of claim 1, further comprising a locking mechanism for selectively locking and unlocking the drawers.

3. The unit dose medication dispensing cart of claim 2, wherein the controller further controls the locking mechanism according to the location information.

4. The unit dose medication dispensing cart of claim 1, further comprising a sensor for sensing access status of the drawers, and informing an external device when the drawer is opened.

5. A computerized unit dose medication dispensing cart, comprising:
a plurality of drawers for holding prepackaged unit dose medications;
a plurality of indicators, each, capable of emitting a light signal, is mounted on one of the drawers;
a tag reader for retrieving identification information from a tag; and
a computer receiving the identification information from the tag reader, retrieving medication information corresponding to the identification information from a remote database, identifying one of the drawers accordingly, and triggering the indicator corresponding to the identified drawer to emit the light signal.

6. The computerized unit dose medication dispensing cart of claim 5, wherein the tag is an RFID reader, and the tag is an RFID tag.

7. The computerized unit dose medication dispensing cart of claim 5, further comprising a locking mechanism for locking the drawers as default and unlocking the drawer identified by the computer.

8. The computerized unit dose medication dispensing cart of claim 5, further comprising a sensor for sensing access status of the drawers, and keeping a record when the drawer is opened.

9. The computerized unit dose medication dispensing cart of claim 5, further comprising a wireless communication module for communicating with an external device.

10. The computerized unit dose medication dispensing cart of claim 5, further comprising a user interface presenting the medication information corresponding to the identification information.

11. The computerized unit dose medication dispensing cart of claim 5, wherein the identification information identifying a patient, and the medication information comprises prescription information specifying a prepackaged unit dose medication intended for the patient, and pharmaceutical information specifying characteristics of contents of the prepackaged unit dose medication.

12. A computerized unit dose medication dispensing system, comprising:
a dispensing cart for transporting prepackaged unit dose medications, comprising:
a plurality of drawers for containing prepackaged unit dose medications;
a plurality of indicators, each of which is mounted on one of the drawer, capable of emitting a light signal;
a tag reader for retrieving identification information from a tag;
a database storing medication information corresponding to the identification information; and
a computer receiving the identification information from the tag reader, retrieving medication information corresponding to the identification information from the database, identifying one of the drawers accordingly, and triggering the indicator corresponding to the identified drawer to emit the light signal.

13. The computerized unit dose medication dispensing system of claim 12, wherein the tag is a RFID reader, and the tag is a RFID tag.

14. The computerized unit dose medication dispensing system of claim 12, wherein the dispensing cart further comprises a locking mechanism for locking the drawers as default and unlocking the drawer identified by the computer.

15. The computerized unit dose medication dispensing system of claim 12, wherein the dispensing cart further comprises a sensor for sensing access status of the drawers and keeping a record when the drawer is opened.

16. The computerized unit dose medication dispensing system of claim 12, further comprising a wireless communication network connecting the dispensing cart, the tag reader, the database, and the computer.

17. The computerized unit dose medication dispensing system of claim 12, wherein the computer further comprises a user interface presenting the medication information corresponding to the identification information.

18. The computerized unit dose medication dispensing system of claim 12, wherein the identification information identifies a patient, and the database further stores prescription information specifying a prepackaged unit dose medication intended for the patient, and pharmaceutical information specifying characteristics of contents of prepackaged unit dose medication.

19. A method for performing unit dose medication dispensing, comprising:
providing a dispensing cart for transporting prepackaged unit dose medications, comprising:
a plurality of drawers for containing prepackaged unit dose medications;
a plurality of indicators, each of which is mounted on one of the drawer and capable of emitting a light signal;
retrieving patient identification information from a first tag;
retrieving medication information according to the identification information retrieved from the first tag; and
controlling operation of the dispensing cart according to the medication information.

20. The method of claim 19, further comprising:
retrieving an operator identification information from a second tag; and
determining whether the operator identification information conformed to a preset setting.

21. The method of claim 19, wherein the retrieving medication information further comprises:
retrieving prescription information according to the patient identification information; and
retrieving medication information according to the prescription information.

22. The method of claim 21, further presenting the prescription information and the medication information.

23. The method of claim 19, further comprising identifying one of the drawers accordingly, and triggering the indicator corresponding to the identified drawer to emit the light signal.

24. The method of claim 19, further locking the drawers as default and unlocking the drawer identified.

25. The method of claim 19, further sensing access status of the drawers, keeping a record when the drawer is opened.
